(19) United States
(12) Patent Application Publication
(10) Pub. No.: US 2017/0112704 A1
(43) Pub. Date: Apr. 27, 2017

(54) STRAP FOR INVERSION THERAPY TABLE

(71) Applicant: On Chong, Sunnyvale, CA (US)

(72) Inventor: On Chong, Sunnyvale, CA (US)

(21) Appl. No.: 15/088,788

(22) Filed: Apr. 1, 2016

Related U.S. Application Data
(60) Provisional application No. 62/245,157, filed on Oct. 22, 2015.

(51) Int. Cl. A61H 1/02; A61G 13/10; A61G 13/00

(52) U.S. Cl. CPC A61H 1/0229; A61G 13/009; A61G 13/107; A61H 2203/0493

(57) ABSTRACT

A strap for a table having a backrest with a first end and a second end. The strap has a first end and a second end, wherein the first end of the strap is connected to the first end of the table backrest and the second end of the strap is connected to the middle portion of the second end of the table backrest. The strap provides a safety measure in the event the user shifts or slips when using the table. When used on an inversion therapy table, the strap may also enable the user to relieve pressure applied to the ankles and lower legs during inversion therapy. The strap may further include a length adjuster to fit the size of each individual user as well as visual length markers to indicate the adjustment settings for the strap.

### BACKGROUND

This application claims priority to U.S. provisional patent application Ser. No. 62/245,157, filed Oct. 22, 2015 and is hereby incorporated by reference herein.

### FIELD OF THE INVENTION

Generally, the present invention relates to a strap for an inversion therapy table that may provide relief for the user's ankles and lower legs while inverting as well as providing a safety measure to help prevent serious injury, in the event that the user shifts, slips or falls out of the inversion table.

### DESCRIPTION OF RELATED ART

Inversion therapy involves lying flat on your back at an angle or hanging upside down, in head-down position. Current inversion therapy tables rely on the user's ankles and lower legs to hold the user in place while inverting and during inversion therapy. During inversion, the body weight shifts towards the upper body at the downward position, which can cause discomfort or pain, particularly to the ankles. In addition, users who do not properly lock their ankles into place prior to inverting risk slipping or falling off the inversion table. This risk is increased for new users who are not familiar with inversion tables.

Current inversion therapy tables do not have a mechanism to help reduce the pressure applied to the ankles and lower legs while inverting. Current inversion therapy tables also do not have adequate security measures to help prevent or reduce the likelihood of slipping or falling out of the table.

One inversion table, the TruBalance Synergy NL Pro Deluxe Inversion Table, provides a single cross body strap for the user. However, the upper strap (nearest the user's upper body) passes around the side of the table rather than an area above the user's shoulder. The shoulder is a preferred area to support the user's body weight when in an inverted position. Thus, it is not apparent that the single strap would be able to retain the user on the table in the event of a slip or fall due to the mounting point of the upper strap. Moreover, only a single strap is provided. Because a single strap only supports one side of the user's body, the single strap would provide uneven pressure on the user and therefore is not a preferred way to support the user during inversion therapy to relieve pressure on the user's ankles.

The strap on the TruBalance table is adjustable, but the strap does not provide any markings to denote where the user has adjusted the strap length. As a result, the user cannot easily confirm whether the strap length has been adjusted since a prior use of the table or be able to adjust the strap to a prior preferred length. The strap also does not have any sort of elastic section to provide for a steady inversion and reduce shock from the strap if the user were to slip on the table.

The present disclosures address at least some of the issues described above.

### SUMMARY OF THE INVENTION

The following presents a simplified summary of the invention in order to provide a basic understanding of some aspects of the invention. This summary is not an exhaustive overview of the invention. It is not intended to identify key or critical elements of the invention or to delineate the scope of the invention. Its sole purpose is to present some concepts in a simplified form as a prelude to the more detailed description that is discussed later.

The embodiments herein provide for a method, system and apparatus wherein a strap is attached to a table. The strap may support the user to provide both safety and comfort. The strap is configured such that it may support the user's shoulder while the user is inverted on the inversion table. In the event the user shifts or slips on the inversion table, the strap may support the user to prevent him from sliding or falling out of the inversion table. One embodiment utilizes two straps to support both user's shoulders. The strap may also be adjusted to support a portion of the user's weight, which decreases pressure on the user's ankles and lower legs when using the inversion table. This can make use of the inversion table a more comfortable experience. The strap may also be adjusted so that the user wears the strap but none of the user's body weight is supported by the strap during inversion therapy. This provides the user with the inversion therapy experience provided by the prior art inversion tables but with the added benefit of safety in the event the user were to slip on the table.

The strap may further include additional features to enhance the user experience. The strap may be adjusted to different lengths via a length adjuster. The strap may have visual length markers so that the adjustments provide even support to the user and are repeatable. Examples of such markers include numbered lines or colored lines, symbols, or a combination thereof. The strap may include a releasable connection, such as a buckle, to allow the user to more quickly wear or remove the strap. The strap may also include an elastic band to provide the user with a steady inversion as the user's weight shifts as well as reduce shock from the strap if the user slips or falls on the table.

While the invention is discussed in the context of inversion tables, the strap may also be used on any exercise equipment wherein the user will be in an inverted position, e.g. the user's head is lower than the user's hips. For example, the strap of the present invention could be attached to a weight lifting bench that has an adjustable surface such that the user is in an inverted position.

### BRIEF DESCRIPTION OF THE FIGURES

The disclosed subject matter will hereafter be described with reference to the accompanying drawings, wherein like reference numerals denote like elements, and:

FIG. 1 provides a perspective view of an inversion table with a strap in accordance with some embodiments of the present invention.

FIG. 2 provides a perspective view of the rear of the backrest and headrest sections of the inversion table showing an exemplary type of attachment of the strap to the inversion table.

FIG. 3 provides a perspective view of the inversion table with a user during inversion therapy.

While the disclosed subject matter is susceptible to various modifications and alternative forms, specific embodiments thereof have been shown by way of example in the drawings and are herein described in detail. It should be understood, however, that the description herein of specific embodiments is not intended to limit the disclosed subject matter to the particular forms disclosed, but on the contrary, the intention is to cover all modifications, equivalents, and alternatives falling within the spirit and scope of the disclosed subject matter as defined by the appended claims.

### DETAILED DESCRIPTION

Although specific embodiments of the present invention will now be described with reference to the drawings, it should be understood that such embodiments are by way of example only and merely illustrative of but a small number of the many possible specific embodiments which can represent applications of the principles of the present invention. Various changes and modifications obvious to one skilled in the art to which the present invention pertains are deemed to be within the spirit, scope and contemplation of the present invention as further defined in the appended claims.

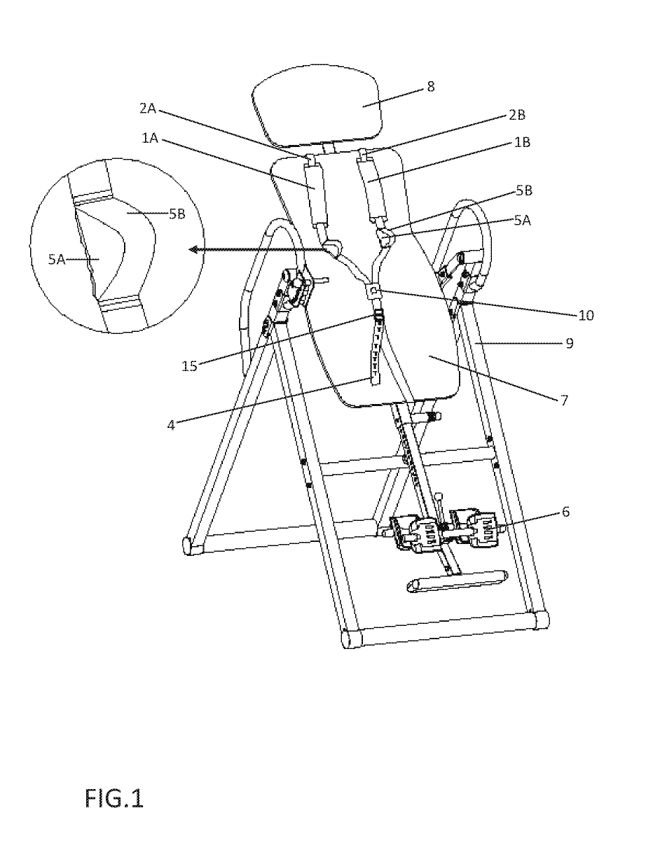

With reference to FIGS. 1 to 3, a strap for an inversion table (9) having an ankle lock (6), a backrest (7), and headrest (8) comprises shoulder harnesses (2A, 2B). The shoulder harnesses (2A, 2B) are mounted such that they pass over the user's shoulder area. If the shoulder harnesses (2A, 2B) are too far apart, the user might not be held or restrained by the strap.

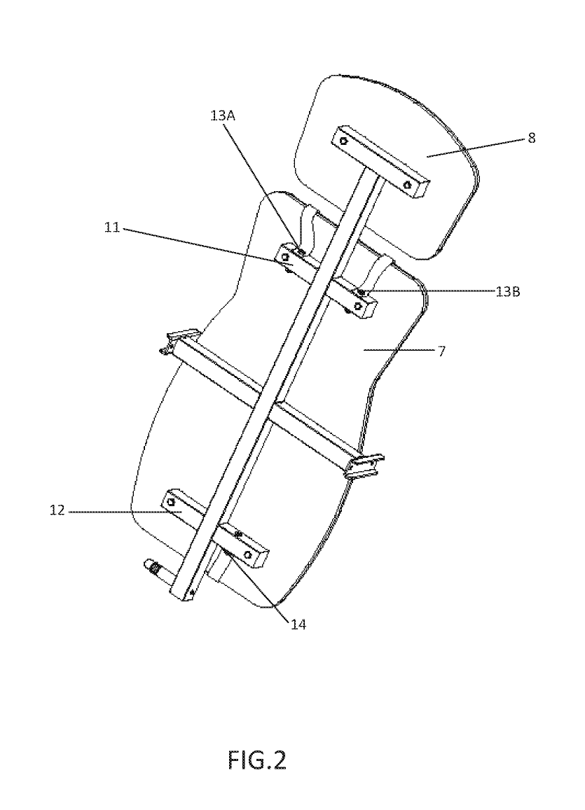

One type of attachment of the strap to the inversion table is illustrated in FIG. 2. The upper end of each shoulder harness (2A, 2B) is attached to a horizontal upper support beam (11) on the rear surface of the backrest (7) by bolts (13A, 13B). From the upper support beam (11), each shoulder harness (2A, 2B) passes over the top of the backrest (7). The shoulder harness attachment points on the upper support beam (11) are sufficiently close together such that the shoulder harness is located generally above the user's shoulder area. In one embodiment, the distance between these attachments points is in the 8 to 10 inch range. The lower end of one of the shoulder harnesses is attached to a horizontal lower support beam (12) on the rear surface of the backrest (7) by a bolt (14). From the lower support beam (12), the lower end of the shoulder harness passes around the middle portion of the lower end of the backrest (7).

The shoulder harnesses may be attached via other means determined by one of ordinary skill in the art, so long as the upper portions of the shoulder harness pass over the user's shoulder when the strap is worn. For example, the upper end of the shoulder harness could be attached to the side of the upper edge of the backrest or the front surface of the backrest (7) rather than the rear surface configuration shown in FIG. 2. Similarly, the shoulder harnesses could be installed in an V pattern across the user's body, such that one shoulder harness goes across the user's right shoulder and then between the user's legs and another shoulder harness goes across the user's left shoulder and then between the user's legs.

As an alternative to using a separate headrest (8) from the backrest (7), a longer one piece backrest that supports both the user's torso and head may be used. For this configuration, the upper ends of the shoulder harnesses (2A, 2B) may be mounted to the front surface of the backrest. Alternatively, the backrest may include holes or slots for the shoulder harnesses (2A, 2B) located above or behind the user's shoulder such that the upper ends of the shoulder harnesses may be attached to the rear of the backrest, as shown in FIG. 2, and pass through the holes or slots to the front of the backrest. So long as the upper ends of the shoulder harnesses are attached in a manner that they pass over the user's shoulders, the upper ends of the shoulder harnesses are considered to be connected to a first end of the backrest.

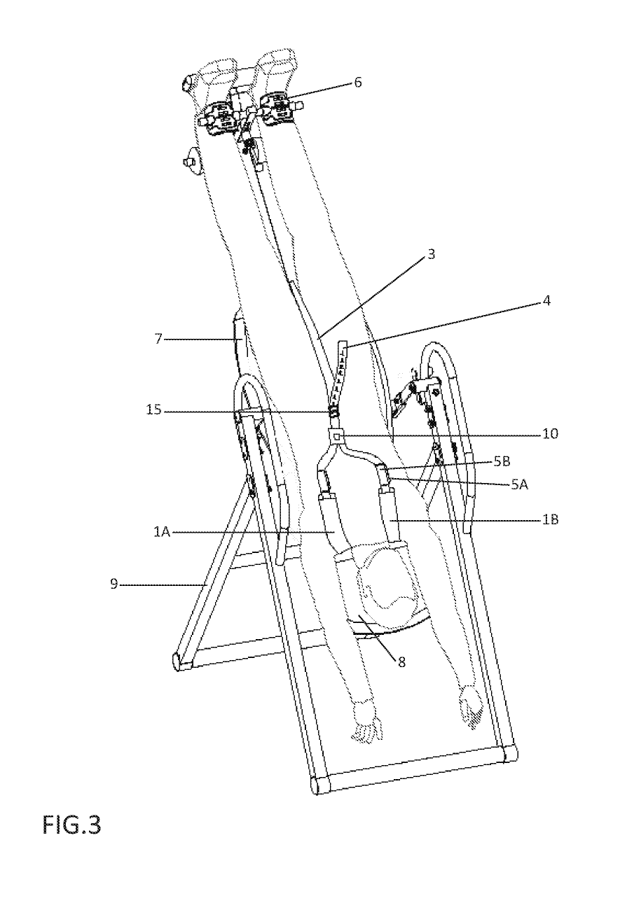

The lower end of one of the shoulder harnesses shown in FIG. 2 is attached such that it passes around the middle portion of the lower end of the backrest. Attached in this manner, the lower portion of the shoulder harness passes between the user's legs, as shown in FIG. 3. So long as the lower end of the shoulder harness is attached to the backrest in a manner that it pass between the user's legs, the lower end of the shoulder harness is considered to be connected to a middle portion of the second end of the backrest.

A shoulder harness may include a length adjuster (15) so that the user can adjust the length of the shoulder harnesses. Examples of adjusters are strap adjusters found on camera bag straps. The length adjuster (15) allows users to control the relief/pressures on their ankles. While inverting with the strap, the pressure is redirected and applied to the user's shoulders. By tightening the straps and shortening the adjustable shoulder harnesses, the pressure on the feet is lessened, but the full benefits of the inversion therapy are also lessened. However, by using inversion therapy in this stage, the user can strengthen their ankle muscles and slowly allow the ankles to withstand pressure without discomfort. By loosening the adjustable shoulders straps, the user is able to receive more of the full benefits of inversion therapy, although loosening the shoulder harnesses applies more pressure on the user's lower legs. The user can also adjust the strap so that it is worn loosely, such that none or very little of the user's weight is supported by the straps during inversion therapy. In this manner, the user may engage in traditional inversion therapy while still retaining the safety benefits of the strap.

The strap may include visual length markers of any length adjustments of the shoulder harness. Visual length markers may include numbered lines (4), letters, differently colored lines or circles, or a combination thereof. The visual length markers allow the user to adjust the straps evenly in order to avoid uneven straps, which can cause an unbalanced relief and/or extra pressure on one ankle. Thus, the visual indications help ensure the pressure relief on both ankles is balanced.

Each shoulder harness (2A, 2B) may include an elastic band (5A) that is attached at each end along the length of the shoulder harness. See the enhanced view of this configuration in FIG. 1. The attachment may be accomplished by sewing the end of the elastic band to the shoulder harness. The elastic band (5A) has a length in its unstretched state and a maximum stretched length. The elastic band is attached to the shoulder harness (5B) such that the distance along the shoulder harness between the band attachment points is greater than the unstretched length of the band and less than the maximum stretched length of the band. Accordingly, when the elastic band is not stretched, the shoulder harness adjacent the band will be shortened, forming a loop. As the elastic band is stretched, the shoulder harness adjacent to the band will gradually straighten until it completely straightens, at which point the elastic band will not stretch any farther. While inverting, the elastic bands assist by slowly easing the user down the inversion table and allows for a more steady inversion. Thus, the bands (5A) may provide a smoother inversion.

The shoulder harnesses (2A, 2B) may include cushions (1A, 1B) positioned over the user's shoulder while the strap is in use to provide the user with additional comfort. The cushions (1A, 1B) are moveable on the shoulder harnesses (2A, 2B) so that the user can adjust where the cushions are positioned. The cushions may be made of any soft, flexible material, such as foam and/or thick cloth.

The shoulder harnesses (2A, 2B) may be made of any weight supporting material, such as nylon.

The particular embodiments disclosed above are illustrative only, as the disclosed subject matter may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the disclosed subject matter. Accordingly, the protection sought herein is as set forth in the claims below.

What is claimed is:

1. A strap for a table having a backrest having a first end and a second end, the second end having a middle portion, the strap comprising:
a first end and a second end, the first end for connecting to the first end of the backrest and the second end for connecting to the middle portion of the second end of the backrest.

2. The strap of claim 1, further comprising
a releasable connection on the first strap in between the first end and second end of the first strap.

3. The strap of claim 2, further comprising
a second strap having a first end and a second end, the first end for connecting to the first end of the backrest and the second end connected to the releasable connection.

4. The strap of claim 3, wherein
the first strap and the second strap are spaced less than a shoulder width apart adjacent the first end of the backrest.

5. The strap of claim 1, wherein
the first strap includes a length adjuster.

6. The strap of claim 5, wherein
the first strap includes visual length markers adjacent the length adjusters.

7. The strap of claim 1, wherein
the first strap includes a cushion located near the first end of the strap.

8. The strap of claim 1, further comprising
an elastic band having a first end and a second end and having an unstretched length and a maximum stretched length, wherein the first end and second end of the elastic band are connected to the first strap such that the distance between the connection points on the first strap are greater than the unstretched length of the elastic band and less than the maximum stretched length of the elastic band.

9. The strap of claim 1, wherein
the table is an inversion table.

10. A table having a first strap and a backrest, wherein:
the backrest has a first end and a second end, the second end having a middle portion;
the first strap has a first end and a second end, the first end for connecting to the first end of the backrest and the second end for connecting to the middle portion of the second end of the backrest.

11. The table of claim 10, further comprising
a releasable connection on the first strap in between the first end and second end of the first strap.

12. The table of claim 11, further comprising
a second strap having a first end and a second end, the first end for connecting to the first end of the backrest and the second end connected to the releasable connection.

13. The table of claim 12, further comprising
the first strap and the second strap are spaced less than a shoulder width apart adjacent the first end of the backrest.

14. The table of claim 10, wherein
the first strap includes a length adjuster.

15. The table of claim 14, wherein
the first strap includes visual length markers adjacent the length adjusters.

16. The table of claim 10, wherein
the first strap includes a cushion located near the first end of the strap.

17. The table of claim 10, further comprising
an elastic band having a first end and a second end and having an unstretched length and a maximum stretched length, wherein the first end and second end of the elastic band are connected to the first strap such that the distance between the connection points on the first strap are greater than the unstretched length of the elastic band and less than the maximum stretched length of the elastic band.

18. The table of claim 10, wherein
the table is an inversion table.

19. An inversion table comprising:
a backrest having a first end and a second end, the second end having a middle portion;
a first strap having a first end and a second end, the first end for connecting to the first end of the backrest and the second end for connecting to the middle portion of the second end of the backrest;
a releasable connection on the first strap in between the first end and second end of the first strap;
a second strap having a first end and a second end, the first end for connecting to the first end of the backrest and the second end connected to the releasable connection;
the first strap and the second strap are spaced less than a shoulder width apart adjacent the first end of the backrest;
the first strap includes a length adjuster;
the first strap includes visual length markers adjacent the length adjusters;
the first strap includes a cushion located near the first end of the strap;
a first elastic band having a first end and a second end and having an unstretched length and a maximum stretched length, wherein the first end and second end of the elastic band are connected to the first strap such that the distance between the connection points on the first strap is greater than the unstretched length of the first elastic band and less than the maximum stretched length of the first elastic band; and
a second elastic band having a first end and a second end and having an unstretched length and a maximum stretched length, wherein the first end and second end of the elastic band are connected to the second strap such that the distance between the connection points on the second strap is greater than the unstretched length of the second elastic band and less than the maximum stretched length of the second elastic band.
